(19) United States
(12) Patent Application Publication
(10) Pub. No.: US 2011/0170295 A1
(43) Pub. Date: Jul. 14, 2011

(54) HEAT-DISSIPATING STRUCTURE FOR LED STREET LAMP

(76) Inventor: Ching-Hang Shen, Sinjhuang City (TW)

(21) Appl. No.: 12/686,523

(22) Filed: Jan. 13, 2010

(51) Int. Cl. F21V 29/00

(52) U.S. Cl. 362/294

(57) ABSTRACT

A heat-dissipating structure for LED street lamp includes a street lamp body and at least one heat-dissipating fan. One end of the street lamp body has a lampshade. The interior of the lampshade is provided with LED modules. The interior of the street lamp body has a penetrating channel and is provided with an opening and a vent. The heat-dissipating fan is disposed in the channel. By means of the opening and the vent, the heat-dissipating fan generates airflow in the channel and makes the airflow to flow to the LED modules. With this arrangement, the heat-dissipating efficiency of the LED modules can be increased sufficiently. Further, the illumination of the street lamp body can be improved in an energy-saving way.

### BACKGROUND OF THE INVENTION

1. Field of the Invention

The present invention relates to a street lamp, and in particular to a heat-dissipating structure of high heat-dissipating efficiency for a street lamp in which light-emitting diodes are used as light sources.

2. Description of Prior Art

Street lamps are widely used in illuminating streets or roads. Under the considerations of environmental protection and energy saving, many manufacturers develop novel street lamps using halogen bulbs, fluorescent lamps, mercury bulbs and sodium lamps as light sources to replace the traditional incandescent bulbs that consume a lot of energy and violate the environmental protection. In comparison with the above-mentioned light sources, light-emitting diodes have an advantage of consuming less energy, so that they are widely used in various illuminating devices, and especially used in street lamps.

The light-emitting diodes (LED) are electro-luminescent and have features of low consumption of electricity, saving energy, long life, low pollution, no warm-up time, fast response and high efficiency. Since the street lamp needs high illumination, high-power light-emitting diodes are usually used as light sources in the street lamps. By applying larger current on the light-emitting diodes, they can emit light with higher illumination.

However, with the increase of illumination, the heat generated by the light-emitting diodes will be inevitably raised. Thus, if the heat generated cannot be dissipated immediately, the heat will be accumulated in the light-emitting diodes, which reduces the light-emitting efficiency and life of the light-emitting diodes. Since there are many street lamps using the light-emitting diodes as light sources but their heat-dissipating efficiency is insufficient, the street lamps using LEDs as light sources may be overheated to break down easily. Further, the light emitted by the LEDs may be decayed rapidly and thus its lifetime is shortened.

In view of the above, it is an important issue for the present inventor and the manufacturers in this art to dissipate the heat generated by the LEDs immediately and smoothly without affecting the efficiency and life thereof.

### SUMMARY OF THE INVENTION

In order to solve the above problems, an objective of the present invention is to provide a heat-dissipating structure for LED street lamp, which is capable of increasing the heat-dissipating efficiency.

In order to achieve the above objective, the present invention is to provide a heat-dissipating structure for LED street lamp, which includes a street lamp body and at least one heat-dissipating fan. One end of the street lamp body has a lampshade. The interior of the lampshade is provided with LED modules. The interior of the street lamp body has a penetrating channel in which the heat-dissipating fan is provided. The heat-dissipating fan generates airflow in the channel and makes the airflow to flow to the LED modules. With this arrangement, the heat-dissipating efficiency of the whole LED modules can be increased sufficiently.

In order to make the Examiner to further understand the characteristics and technical contents of the present invention, a description relating thereto will be made with reference to accompanying drawings. However, the drawings are illustrative only, but not used to limit the scope of the present invention.

### BRIEF DESCRIPTION OF THE DRAWINGS

FIG. 1 is an exploded perspective view showing a preferred embodiment of the present invention;

FIG. 2 is a partially cross-sectional view showing the preferred embodiment of the present invention;

FIG. 3 is a schematic view showing an operating state of the preferred embodiment of the present invention;

FIG. 4 is an exploded perspective view showing another preferred embodiment of the present invention;

FIG. 5 is a partially cross-sectional view showing another preferred embodiment of the present invention; and

FIG. 6 is a schematic view showing an operating state of another preferred embodiment of the present invention.

### DETAILED DESCRIPTION OF THE INVENTION

The above-mentioned objectives, structural and functional characteristics of the present invention will be described with reference to the following preferred embodiments and the accompanying drawings.

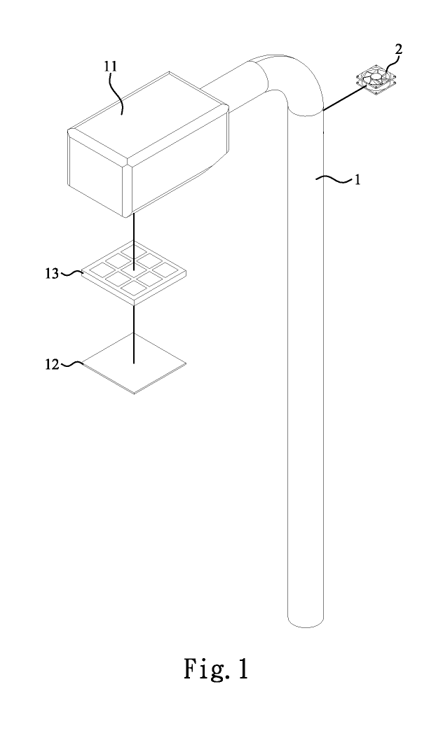

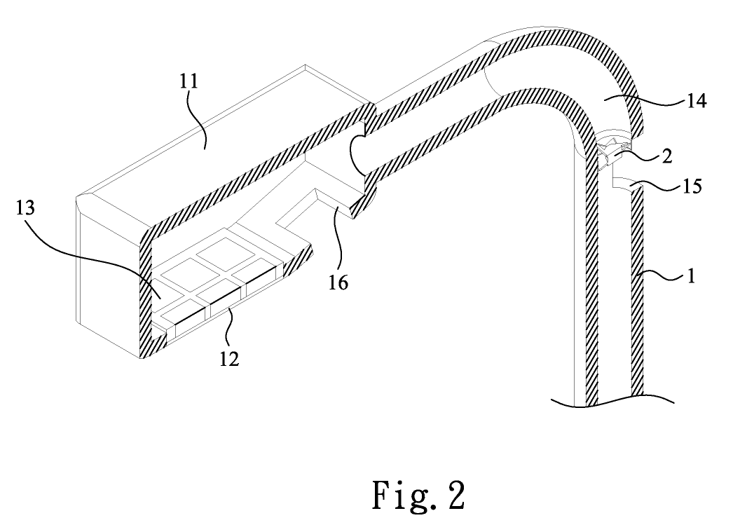

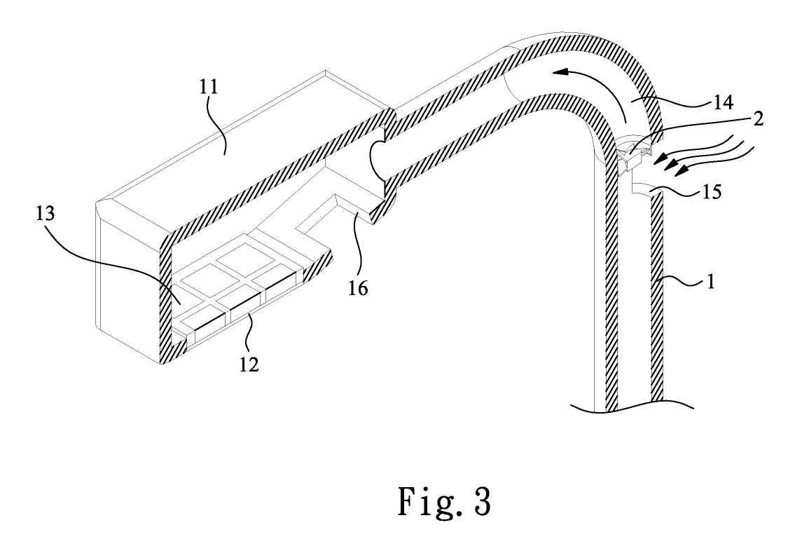

Please refer to FIGS. 1 to 3. The present invention provides a heat-dissipating structure for a LED street lamp. In a preferred embodiment of the present invention, the heat-dissipating structure for a LED street lamp includes a street lamp body 1 and at least one heat-dissipating fan 2. One end of the street lamp body 1 has a lampshade 11. One side of the lampshade 11 has a light-transmitting cover 12. The interior of the lampshade 11 is provided with a LED module 13. The light generated by the LED module 13 is emitted through the light-transmitting cover 12. The interior of the street lamp body 1 is hollow to form a penetrating channel 14. The channel 14 communicates with the lampshade 11. The street lamp body 1 is provided with an opening 15 adjacent to the lampshade 11. The heat-dissipating fan 2 is disposed in the street lamp body 1 through the opening 15 for generating airflow in the channel 14. The heat-dissipating fan 2 is disposed in the intersection between the opening 15 and the channel 14 of the street lamp body 1. After being electrically connected to a power source, the heat-dissipating fan 2 starts to generate airflow flowing through the channel 14 and towards the lampshade 11. The street lamp body 1 is further provided with a vent 16. After being electrically connected to the power source, the LED module 13 emits light, and the light is emitted through the light-transmitting cover 12. The LED module 13 also generates heat. When the heat-dissipating fan 2 is electrically connected to the power source, the airflow generated thereby in the channel 14 flows into the lampshade 11 and takes away the heat generated by the LED module 13. The airflow generated by the heat-dissipating fan 2 is exhausted from the vent 16. Thus, the heat generated by the LED module 13 can be dissipated through the vent 16 by means of the convection of the airflow generated by the heat-dissipating fan 2. The flowing airflow can reduce the temperature around the LED module 13 sufficiently and enhance the heat-dissipating efficiency of the LED module 13. Therefore, the illumination of the street lamp body 1 can be increased in an energy-saving way.

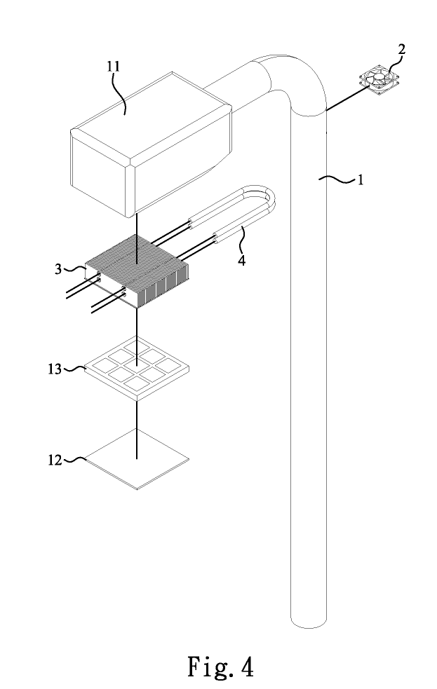

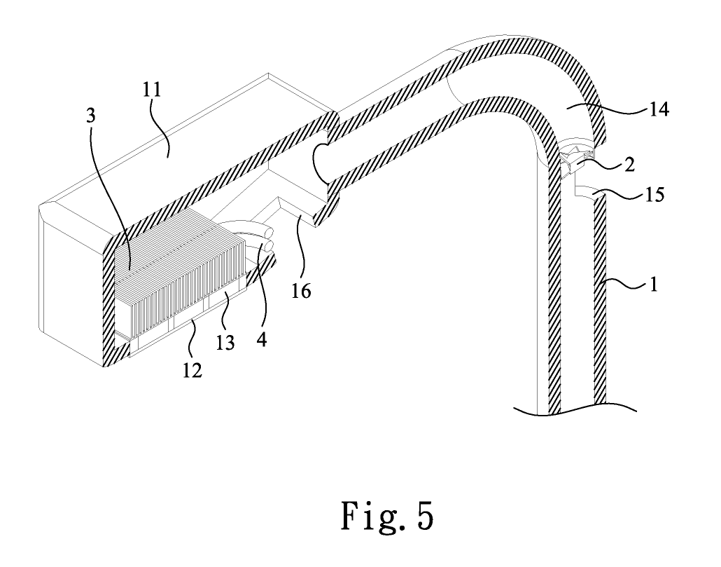

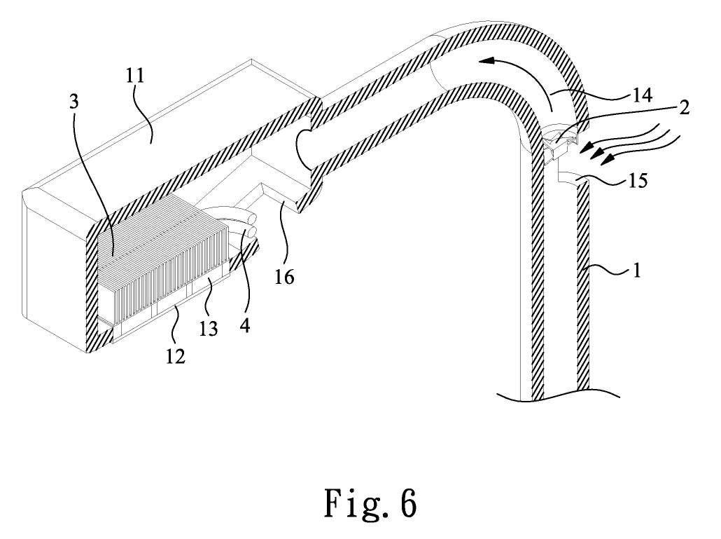

Please refer to FIGS. 4 to 6, which show another preferred embodiment of the present invention. The whole construction of the present embodiment is substantially the same as that of the previous embodiment, and thus the repeated description is omitted for simplicity. The only difference between the present embodiment and the previous embodiment lies in that the LED module 13 is provided with a heat sink 3. The heat sink 3 is provided with heat pipes 4. When the LED module 13 is electrically connected to the power source to emit light, the light is transmitted through the light-transmitting cover 12. The heat generated by the LED module 13 is conducted by the heat sink 3 and the heat pipes 4 and then dissipated to the outside through the vent 16. Further, by means of the convection of the airflow generated by the heat-dissipating fan 2, the heat absorbed by the heat sink 3 can be dissipated to the outside rapidly through the vent 16 by means of the airflow generated by the heat-dissipating fan 2 flowing from the opening 15 into the lampshade 11. In this way, the heat-dissipating efficiency of the LED module 13 can be increased sufficiently and the illumination of the street lamp body 1 can be improved in an energy-saving way.

According to the above, the present invention provides a heat-dissipating structure for LED street lamp and has advantages features as follows:

(1) excellent heat-dissipating efficiency;

(2) good thermal-conducting efficiency;

(3) easy detachment and maintenance; and

(4) energy-saving and increased illumination.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A heat-dissipating structure for LED street lamp, including:
a street lamp body with its one end having a lampshade, the interior of the lampshade being provided with at least one LED module, the interior of the street lamp body having a channel communicating with the LED module; and
at least one heat-dissipating fan disposed in the channel for generating airflow in the channel.

2. The heat-dissipating structure for LED street lamp according to claim 1, wherein the street lamp body is provided with an opening at a position corresponding to that of the heat-dissipating fan, the heat-dissipating fan is disposed in the opening so as to generate airflow in the channel.

3. The heat-dissipating structure for LED street lamp according to claim 1, wherein the LED module is provided with a heat sink.

4. The heat-dissipating structure for LED street lamp according to claim 1, wherein the street lamp body is provided with a vent for exhausting the airflow generated by the heat-dissipating fan, so that heat generated by the LED module is exhausted from the vent by means of the convection of the airflow generated by the heat-dissipating fan.

5. The heat-dissipating structure for LED street lamp according to claim 3, wherein the heat sink is provided with a heat pipe.
